(19) United States
(12) Patent Application Publication
(10) Pub. No.: US 2023/0125721 A1
(43) Pub. Date: Apr. 27, 2023

(54) SAFETY AIR VALVE SWITCH FOR A PRESSURIZED AIR LINE

(71) Applicant: Dan Swanson, Chicago, IL (US)

(72) Inventor: Dan Swanson, Chicago, IL (US)

(21) Appl. No.: 17/970,254

(22) Filed: Oct. 20, 2022

Related U.S. Application Data
(60) Provisional application No. 63/270,649, filed on Oct. 22, 2021.

(51) Int. Cl. F16K 17/02

(52) U.S. Cl. CPC F16K 17/02

(57) ABSTRACT

A safety air valve switch for a pressurized air line is provided. The valve may be in the form of an exterior sliding sleeve. The safety air valve switch for a pressurized air line moves between an open and a closed position. In the open position the safety air valve allows pressurized air to flow through an air line of, for example, a tire inflation hose. In the closed position the safety air valve switch prohibits the flow of air through the air line. The safety valve allows for safe venting of pressurized air when switching between the open and closed position.

### REFERENCE TO RELATED APPLICATIONS

This application claims priority to U.S. Provisional Application No. 63/270,649 titled “SAFETY AIR VALVE SWITCH FOR A PRESSURIZED AIR LINE” which was filed on Oct. 22, 2021, the entire contents of which are incorporated by reference herein.

### BACKGROUND OF THE INVENTION

A safety air valve switch for a pressurized air line is provided. The valve may be in the form of an exterior sliding sleeve. The safety air valve switch for a pressurized air line moves between an open and a closed position. In the open position the safety air valve allows pressurized air to flow through an air line of, for example, a tire inflation hose. In the closed position the safety air valve switch prohibits the flow of air through the air line. The safety valve allows for safe venting of pressurized air when switching between the open and closed position.

Valves for air lines common. For example, U.S. Pat. No. 10,481,621 to Inoue discloses an air pressure control device having first and second housings, a diaphragm partitioning an inner space of the housings into a first air chamber (one air chamber) and a second air chamber (the other air chamber), a valve seat supported by the diaphragm, a valve member arranged in the first air chamber and closing or opening a through-hole in the valve seat, a pressure adjusting mechanism (including a pressure adjusting bolt and an upper seat) that adjusts a force applied to the diaphragm from a side including the second air chamber, and a main spring (compression coil spring) disposed in the second air chamber and applying a spring force to a lower seat (spring receiving member) disposed on the valve seat. A bearing is interposed between the valve seat and the lower seat.

Further, U.S. Pat. No. 9,108,474 to Chu discloses a relief-valve device for an air pressure gauge having a casing, a relief-valve assembly, a valve shaft, and a push button. The casing has a connecting member, a pressure detecting member and a discharging member. The relief-valve assembly is mounted in the discharging member and has a valve seat, a first seal ring, a second seal ring and a mounting cover. The valve shaft is mounted axially slidably in the relief-valve assembly and has a shaft member and a valve head. The shaft member has a discharging notch selectively aligning with the second seal ring to allow high pressure air in an inflatable product connecting to the air pressure gauge to be discharged slowly and finely out of the relief-valve device.

Still further, U.S. Pat. No. 9,316,325 to Franzen discloses a valve housing having a spool and the spool has a regulating chamber selectively communicating a supply line to a return line. The spool is biased in one direction by a spring force and there is a second force biasing the spool in an opposed direction with the second bias force being provided by a fluid pressure within a hydraulic system associated with the pressure regulating valve. The amount of communication between the supply port and the return port is regulated by a position of the spool as the bias force from the fluid pressure change. Damper chambers are provided on opposed sides of the spool and serve to dampen a speed of movement of the spool and a supply line for supplying fluid into the damper chambers through check valves. The supply line serves to assist in purging air outwardly of the damper chambers.

However, these patents fail to describe a safety air valve switch for a pressurized air line which is easy to use. Further, these patents fail to provide for a safety air valve switch for a pressurized air line which has an external sliding sleeve for easily venting pressurized air.

### SUMMARY OF THE INVENTION

A safety air valve switch for a pressurized air line is provided. The valve may be in the form of an exterior sliding sleeve. The safety air valve switch for a pressurized air line moves between an open and a closed position. In the open position the safety air valve allows pressurized air to flow through an air line of, for example, a tire inflation hose. In the closed position the safety air valve switch prohibits the flow of air through the air line. The safety valve allows for safe venting of pressurized air when switching between the open and closed position.

An advantage of the present safety air valve switch for a pressurized air line is that the present device reduces the risk of injury from the quick release of pressurized air from a pressurized air system.

And another advantage of the present safety air valve switch for a pressurized air line is that the system is easy to use.

Yet another advantage of the present safety air valve switch for a pressurized air line is that the system is durable.

For a more complete understanding of the above listed features and advantages of the safety air valve switch for a pressurized air line reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a cross sectional view of the safety valve in the closed position with respect to an air line.

FIG. 2 illustrates a cross sectional view of the safety valve in the open position the respect to an air line.

FIG. 3 illustrates a cross sectional view of the safety valve in the closed position wherein the air flow is illustrated.

FIG. 4 illustrates a cross section of the sliding sleeve of the system.

FIG. 5 illustrates an exterior view of the openings of the first unit and the second unit of the air line.

### DETAILED DESCRIPTION OF THE PREFERRED EMBODIMENTS

A safety air valve switch for a pressurized air line is provided. The valve may be in the form of an exterior sliding sleeve. The safety air valve switch for a pressurized air line moves between an open and a closed position. In the open position the safety air valve allows pressurized air to flow through an air line of, for example, a tire inflation hose. In the closed position the safety air valve switch prohibits the flow of air through the air line. The safety valve allows for safe venting of pressurized air when switching between the open and closed position.

Referring now to the figures, a safety air valve 1 is provided. The safety air valve 1 is especially suitable for use in connection with a pressurized air line system 10 for which it is connected to. The safety air valve system 10 may have a slidable sleeve 100 and a pressurized air line unit 10. The safety air valve 1 may be made of, for example, a durable, preferably non-corrosive metal material. The pressurized air line system 10 may have a first unit 5 and a second unit 6 wherein the first unit 5 may be electively connected to or removed from the second unit 6. In an embodiment, the pressurized material may be a fluid other than air.

The pressurized air line system 10 may have an exterior surface 11 and an interior 12. Located within the interior 12 of the first unit 5 of the pressurized air line system 10 may be a first tube 20 (or channel) and located within the interior of the second unit 6 may be a second tube (or channel) 21. A plurality of openings 30 may be located at the distal ends of the interior first tube 20 and second tube 21. The openings 30 may allow air to flow out of or into the interior first tube 20 and the second tube 21 as described below. In particular, the openings 30 may allow access to channels 75 which have openings 200, 201 on the exterior surface of the first unit 5 and the second unit 6 (see FIG. 5). More specifically, the openings 30 of the first tube 20 and second tube 21 may allow air to flow into the channels 75 which perpendicularly extend to the exterior surface 11 of the air line 10. The channels 75 terminally end in the openings 200, 201 as shown in FIG. 5. In an embodiment, an internal barrier wall 50 may separate the first interior tube 20 from the second interior tube 21 and may prevent the flow of air between the adjacent ends of the two tubes 20, 21.

Referring now to FIG. 4, in an embodiment, the system 1 may have a slidable sleeve 100. The sleeve 100 may be cylindrical having a first end 101, a second end 102, an exterior surface 120 and an interior surface 130. The interior surface 130 surrounds the air line 10. As a result, the slidable sleeve 100 may have an interior diameter which is substantially equal to or slightly greater than an exterior diameter of the first unit 5 and second unit 6 at the location wherein the slidable sleeve 100 is attached to the first unit 5 and second unit 6.

Located near the second end 102 of the slidable sleeve 100 may be an indented groove 103 which surrounds the first unit 5. Located within the indented groove 103 may be a rubber or plastic o-ring 104 wherein the o-ring 104 provides an air-tight seal between the slidable sleeve 100 and the exterior surface 11 of the first unit 5 or second unit 6 of the air line 10. Located approximately halfway between the first end 101 and second end 102 of the slidable sleeve, slightly closer to the first end 101, may be a second channel 106 which surrounds the second unit 6. Located within the second channel 106 may be a second o-ring 107 which may act in a similar manner as the first o-ring 104 of the indented groove 103.

Located on the interior surface 130 of the slidable sleeve 100 (the surface touching the air line 10 first unit 5 and second unit 6) may be a first hollow extended ring 140 and a second hollow extended ring 150. FIG. 4 illustrates a cross-sectional view of the slidable sleeve 100, so the first hollow extended ring 140 and the second hollow extended ring 150 appear as rectangles, but are actually circular cylindrical rings which surround the first unit 5 and second unit 6. The first hollow extended ring 140 and the second hollow extended ring 150 may provide a hollow gap between the interior surface 130 of the sleeve 100 and the first unit 5 and the second unit 6 of the air line 10 so that air may flow between the first unit 5 and the slidable sleeve 100 and between the second unit 6 and the slidable sleeve 100.

In an embodiment, the second channel 106 (and therefore second o-ring 107) may be located between the first hollow extended ring 140 and the second hollow extended ring 150. In an embodiment, the first hollow extended ring 140 may have a first end 141 and a second end 142. In an embodiment, the second hollow extended ring 150 may have an open first end 151 and a closed second end 152. In particular, the first end 151 of the second hollow extended ring 150 may open directly to the environment so as to allow the venting or pressurized air in a safe manner (as described below).

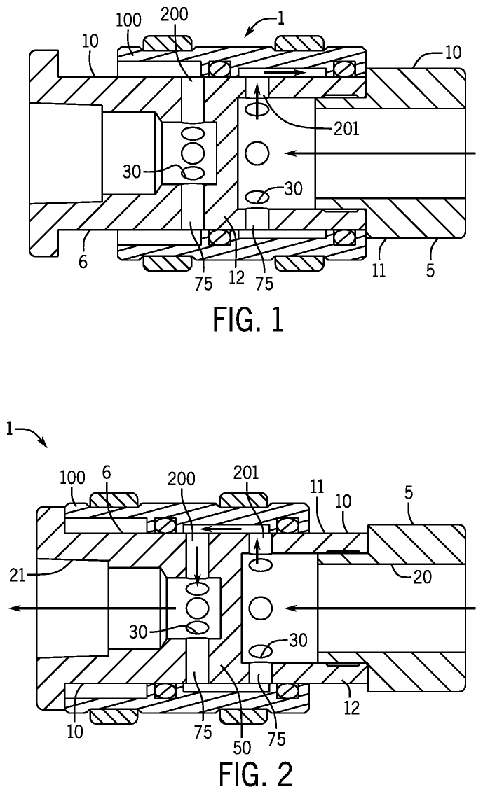

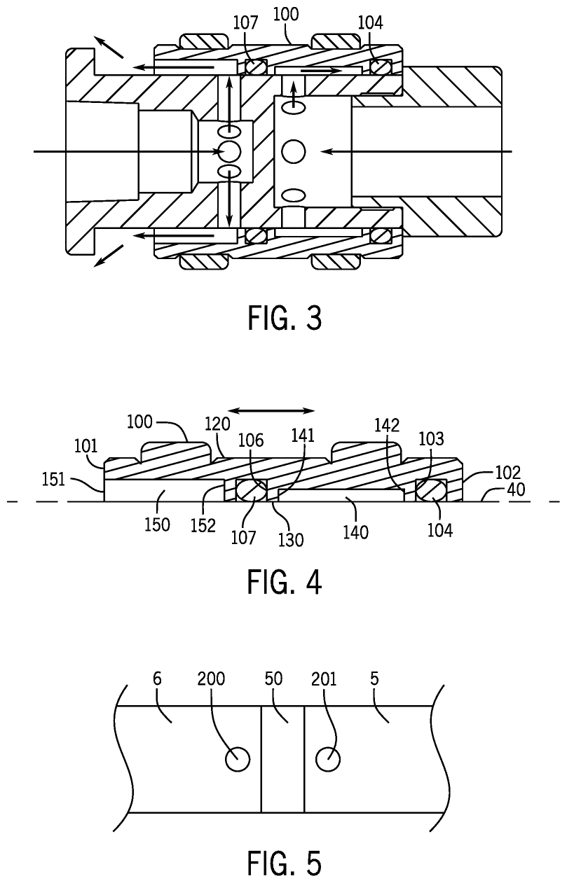

The slidable sleeve 100 may act as a valve controlling the flow or air within the air line 10 between the first unit 5 and the second unit 6. In particular, the slidable sleeve 100 may move from a first position (or “open position” of FIG. 2) to a second position (or “closed position” of FIG. 1). In the first position, the first hollow extended ring 140 of the slidable sleeve 100 connects the two openings 200 and 201 so that air may flow out of the opening of 201 of the first unit 5, through the first hollow extended ring 140, and then into the opening 200 of the second unit 6 so that the air returns back into the air line 10. As a result, when the slidable sleeve 100 is in the first position (the “open position”) air may exit the first unit 5 into the first hollow extended ring 140 of the slidable sleeve 100 and then may return to the second unit 6 while passing around the internal barrier wall 50 which separates the internal ends of the first unit 5 and the second unit 6.

When the slidable sleeve 100 is moved to the closed position of FIG. 1, air that exits the opening 201 of the first unit 5 may not pass to opening 200 of the second unit 6 and the air flow is therefore restricted. At the same time that the slidable sleeve 100 is moved to the closed first position (FIG. 1), pressurized air remaining in the second unit 6 may safely vent out the second hollow extended ring 150 at the opening 151 end of the second hollow extended ring 150. This avoids potential injury to a user.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1) A safety valve for a pressurized air line comprising:
a first unit of the pressurized air line wherein the first unit has an exterior surface and a hollow interior;
a second unit of the pressurized air line wherein the second unit has an exterior surface and a hollow interior;
a barrier located between the first unit and the second unit;
a slidable sleeve having an interior surface and an exterior surface wherein the interior surface of the slidable sleeve covers a portion of the exterior surface of the first unit and a portion of the exterior surface of the second unit;
wherein the air line contains pressurized air;
wherein the slidable sleeve moves from an open position wherein the air may flow from the first unit to the second unit to a closed position and wherein air may not flow from the first unit to the second unit; and
wherein in the open position the pressurized air exits the first unit through an opening on the first unit and enters a first hollow channel of the interior surface of the slidable sleeve and returns to the air line through an opening of the second unit while bypassing the barrier.

2) The safety valve for a pressurized air line of claim 1 further comprising:
a second opening channel on the interior surface of the slidable sleeve wherein the second opening channel on the interior surface of the slidable sleeve has an open first end and a closed second end and wherein air is vented out of the open first end of the second opening channel of the interior surface of the slidable sleeve when the slidable sleeve is in the closed position.

3) The safety valve for a pressurized air line of claim 2 further comprising:
a first o-ring located within an indented groove located between the first opening channel of the interior surface of the slidable sleeve and the second open channel of the interior surface of the slidable sleeve.

4) The safety valve for a pressurized air line of claim 1 wherein the safety valve is made of a non-corrosive metal.

5) The safety valve for a pressurized air line of claim 3 wherein the first opening channel of the interior surface of the slidable sleeve is located between the first o-ring and a second o-ring.
